(19) United States
(12) Patent Application Publication
(10) Pub. No.: US 2024/0311802 A1
(43) Pub. Date: Sep. 19, 2024

(54) CONTACTLESS PROVISIONING SYSTEMS AND METHODS

(71) Applicant: MASTERCARD INTERNATIONAL INCORPORATED, Purchase, NY (US)

(72) Inventors: Vijin Venugopalan, Pleasanton, CA (US); Vairag Jain, Jersey City, NJ (US)

(21) Appl. No.: 18/606,009

(22) Filed: Mar. 15, 2024

Related U.S. Application Data
(60) Provisional application No. 63/452,884, filed on Mar. 17, 2023.

(51) Int. Cl. G06Q 20/36; G06Q 20/32; G06Q 20/34

(52) U.S. Cl. CPC G06Q 20/36; G06Q 20/322; G06Q 20/352

(57) ABSTRACT

Systems, methods, and computer program code are provided to contactlessly provision payment card information into a mobile wallet application of a mobile device are provided.

### RELATED APPLICATIONS

This application claims benefit of and priority to U.S. provisional patent application Ser. No. 63/452,884 filed on Mar. 17, 2023, the entire disclosure of which is hereby incorporated by reference in its entirety for all purposes.

### BACKGROUND

Wallet applications are increasingly used to store payment account information for use in conducting transactions. For example, many mobile devices use wallet applications to allow a mobile device to be used to conduct payment transactions. Payment account information is “provisioned” or stored for use by such wallet applications in a process referred to as “provisioning”. For example, some existing provisioning approaches require a user to manually enter their payment card information into a user interface. Other approaches allow a user to capture an image of a payment card so that image processing techniques can be used to detect the payment card information.

Unfortunately, these provisioning approaches are subject to fraud. A fraudster who has obtained payment account information can manually enter that information in a provisioning process and use that stolen information to conduct wallet transactions. A fraudster may also create a fraudulent payment card using the stolen information and image that fraudulent card for use in a provisioning process.

Further, it is important to verify that a user who provisions payment account information onto a wallet actually has possession of the physical payment card associated with the payment account. Existing provisioning processes do not provide adequate controls or protections to validate that the user has such possession. Some regulators have made it mandatory to require a possession factor in payment card transactions. For example, European regulators have amended the Payment Service Providers Directive (“PSD2”) to require a possession factor in payment card transactions.

It would be desirable to provide an improved provisioning process that enables transactions to comply with any possession requirements as well as to provide a stronger method of verification compared to manual entry processes. It would further be desirable to provide such provisioning processes with an improved customer experience using a simplified provisioning flow.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which are provided for the purpose of illustration only and are not intended to limit the scope of the present disclosure, wherein:

FIG. 1 is a block diagram that illustrates a system for contactlessly provisioning payment credentials to a mobile device pursuant to some embodiments.

FIG. 2 is a flow chart that illustrates a process that may be performed in the system of FIG. 1 pursuant to some embodiments.

FIG. 3 is a process diagram that illustrates messages involved in a contactless provisioning process pursuant to some embodiments.

FIG. 4 is a process diagram that illustrates interactions involved in a contactless provisioning process pursuant to some embodiments.

FIG. 5 is a block diagram illustrating a computing system for use in the examples herein in accordance with some embodiments.

FIG. 6 is an illustrative user interface showing a contactless provisioning interaction pursuant to some embodiments.

### DETAILED DESCRIPTION

Holders of payment cards (hereinafter referred to as “cardholders”) such as credit or debit cards (hereinafter referred to as “payment cards”) enjoy the convenience and security of associating their payment cards with their mobile devices (such as in a mobile wallet application of a mobile phone or the like). By associating a payment card with a wallet application of a mobile device, the cardholder can conduct payment transactions at many merchant devices using their mobile phone. These payment transactions may be conducted by placing the mobile phone in proximity to a merchant terminal (or other point-of-interaction). If both the mobile phone and the merchant terminal are configured to support contactless interactions, the payment card information associated with the mobile phone is securely transmitted to the merchant terminal via near-field communication (“NFC”). As will be described further herein, embodiments allow cardholders to easily associate (or “provision”) their payment card information with a mobile wallet of a mobile device using contactless communication between a payment card and a mobile device. Embodiments provide an improved interaction which utilizes a simplified provisioning flow that minimizes or eliminates any data entry required by the cardholder and which provides more secure verification. Further, embodiments ensure that the cardholder who initiates a contactless provisioning process is in possession of the physical payment card that is being provisioned onto the mobile wallet of the mobile device. Embodiments allow issuers of payment cards to establish rules which control the provisioning process, ensuring that regulatory and other requirements are met and that cardholders are presented with accurate and relevant information during a provisioning flow.

Pursuant to some embodiments, systems, methods and computer program code are provided for contactlessly provisioning payment card information in a wallet application (such as a wallet application of a mobile device). In some embodiments, a process may include receiving, from a mobile device, payment card information including information from a storage device of a payment card over a contactless interface, generating a message requesting whether the payment card is eligible for provisioning on a wallet application, generating a second message requesting that the payment card information be digitized on the wallet application and contactlessly provisioning a tokenized version of the payment card information on the wallet application.

In some embodiments, the payment account information is obtained from a physical payment card associated with a cardholder. For example, the physical payment card may be a contactless payment card which stores payment account information in a chip of the payment card (e.g., such as a so-called “EMV” payment card). The payment account information (and other information such as an application cryptogram) may be contactlessly transmitted from the payment card to a mobile device (via a “tap” or a “dip”).

In some embodiments, the process further includes receiving, in response to the message request whether the payment card is eligible for provisioning, a response message, the response message including a flag, the flag indicating one of a success, a fail, and an issuer validation, and causing a message to be displayed to a user of the mobile device, the contents of the message based on the flag.

In some embodiments, the process further includes determining that a cardholder verification process is required, the determining based on the flag.

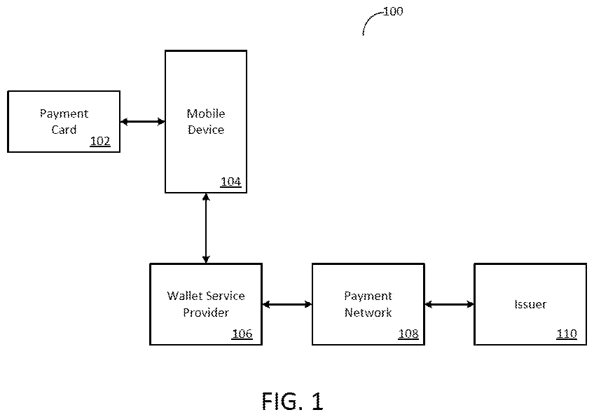

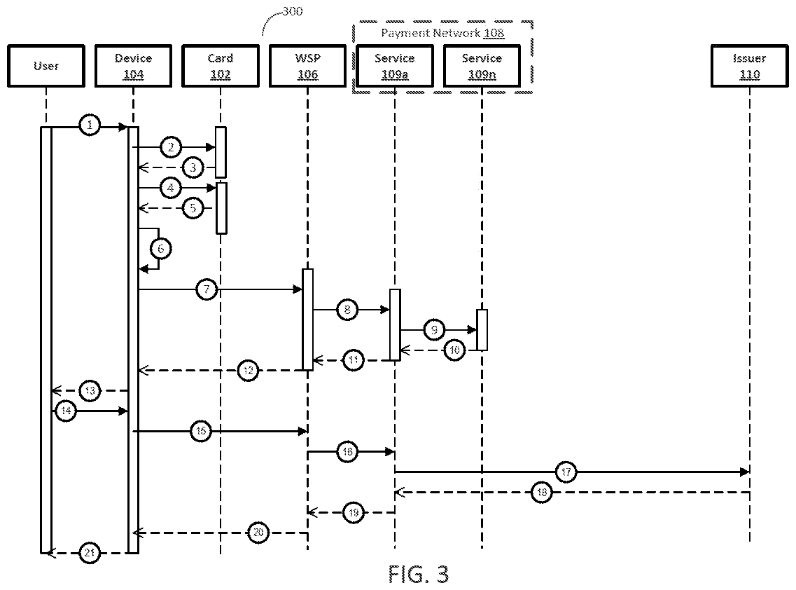

Further details of some embodiments will now be described by reference to the drawings. Referring first to FIG. 1, a system is shown in which embodiments may be implemented. As shown in FIG. 1, a system 100 may include a payment card 102 (e.g., such as an EMV-compatible payment card) which is in communication with a device such as a mobile device 104. In some embodiments, the payment card 102 is in communication with the mobile device 104 via contactless communication such that payment card information stored in a chip of the payment card 102 may be wirelessly (or, as used herein, “contactlessly”) read by the mobile device 104. Details of information read from the payment card 102 are shown in FIG. 3.

The system 100 also includes a wallet service provider system 106 operated by or on behalf of an entity providing the wallet in which the cardholder wishes to provision payment card information. The wallet service provider system 106 performs processing as shown in FIG. 3 to generate messages to check the eligibility of the payment card for provisioning in the wallet and to digitize the payment card information for provisioning in the wallet. The wallet service provider system 106 may also perform processing to determine whether to require PIN entry by the cardholder and to determine whether to require cardholder verification to be performed (e.g., based on rules established by the wallet service provider and/or the payment card issuer).

The system 100 also includes a payment network 108. The payment network 108, for example, may be the payment network operated by MasterCard International Incorporated and may include a number of systems or applications which together perform the processing described herein. For example, the payment network 108 may perform routing functions (e.g., to route a provisioning request to the issuer 110 associated with the payment card 102) and to perform tokenization processing (e.g., to generate a tokenized representation of the payment account information associated with the payment card 102). While only a single payment card 102, mobile device 104, wallet service provider 106, payment network 108 and issuer 110 are shown in FIG. 1, in practical application, multiple devices and systems may be provided.

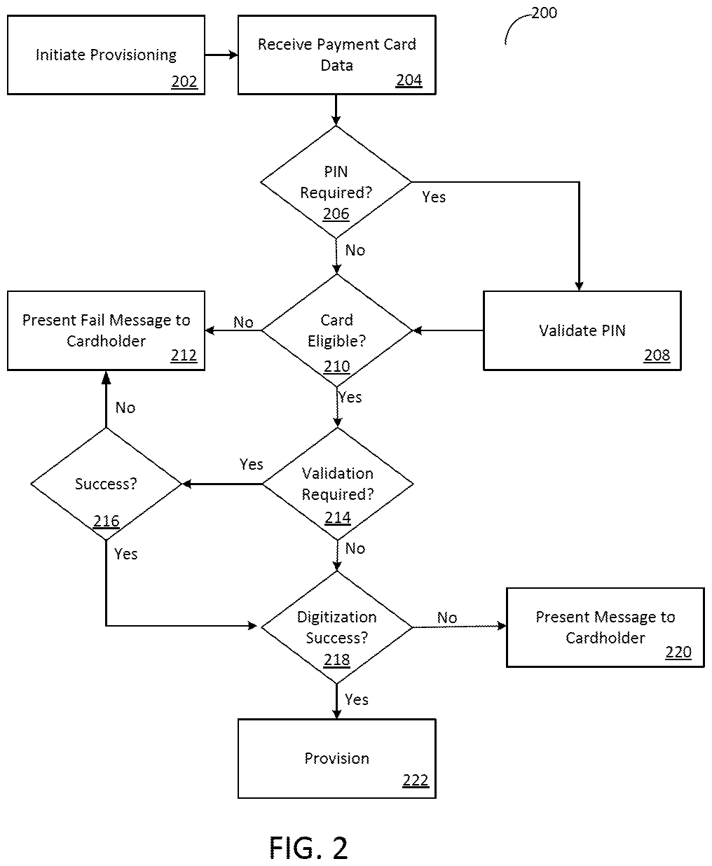

Reference is now made to FIG. 2 where a flow diagram depicting a contactless provisioning process 200 pursuant to some embodiments is shown. The flow charts and descriptions thereof herein should not be understood to prescribe a fixed order of performing the method steps described therein. Rather the method steps may be performed in any order that is practicable.

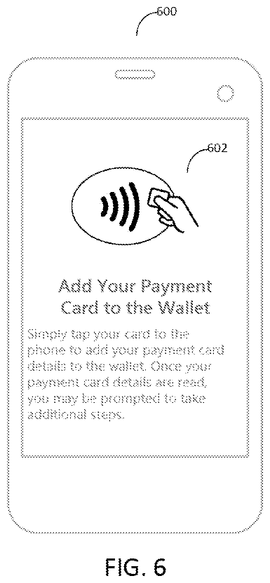

Process 200 begins at 202 where provisioning is requested by a cardholder interacting with a wallet application on a mobile device (such as the device 104 of FIG. 1). Processing at 202 may include the cardholder interacting with a user interface such as the user interface 600 of FIG. 6 to request that a payment card 102 be provisioned on a wallet application of a mobile device 104. At 204, the wallet application (and the wallet service provider) receive payment card data (e.g., based on a contactless interaction between the mobile device 104 and the payment card 102). In some embodiments, a determination may be made at 206 if a PIN is required. For example, the wallet service provider may determine that the issuer requires a PIN or that the provisioning is occurring in a region requiring PIN entry (e.g., such as in a PSD2 region). If a PIN is required, processing may continue to 208 where the PIN is validated.

Processing continues at 210 where a determination is made whether the payment card is eligible for provisioning. This determination may be made based on rules established by the issuer and/or the wallet service provider. The eligibility determination, in some embodiments, involves the generation of a card eligibility request message shown in FIG. 3 (e.g., in conjunction with a checkCard request message transmitted from the wallet service provider to the payment network). If the determination indicates that the payment card is not eligible for provisioning in the wallet, processing continues at 212 where a message is presented to the cardholder. Further details of the card eligibility request message processing is provided in conjunction with the description of FIG. 3 below.

If provisioning is permitted, processing may continue at 214 where a determination is made whether cardholder validation is required. For example, the wallet service provider may determine that entry of a cardholder verification code by the cardholder is required (e.g. to validate that the cardholder has the actual payment card in possession). If validation fails, processing may continue at 212 where a message is presented to the cardholder (e.g., on a screen of the mobile device). The cardholder may be permitted to retry the validation or the process may terminate without provisioning.

If provisioning is permitted, (and if any required validation has successfully been performed), processing continues at 218 for digitization. A digitization message may be transmitted from the wallet service provider to the payment network (and ultimately, in some situations, to the issuer) as shown in the provision message (15) described in FIG. 3). If digitization is successful, the process continues at 222 where a tokenized representation of the payment card information is stored (or provisioned) in the wallet application of the mobile device 104.

The result of this processing is a contactless provisioning process that allows payment card information to be securely provisioned in a mobile wallet without manual data entry by a cardholder. Further, embodiments provide improved security and fraud prevention with a contactless provisioning process that allows wallet service providers and issuers to ensure that the cardholder has possession of the payment card while performing the provisioning process.

Further details of the processing, pursuant to some embodiments, to contactlessly provision a payment card 102 onto a mobile wallet of a mobile device 104 will now be described by reference to the process 300 of FIG. 3. The process 300 of FIG. 3 shows details of a number of messages (and responses) that may be transmitted between devices of the system 100 of FIG. 1. While FIG. 3 uses numbers (such as (1)-(21)) to describe various messages and responses, the numbers are not intended to imply that the messages are performed in a specific sequence or order. The numbers are selected for labeling convenience only. Further, additional messages and responses may be included in the processing of the present invention.

As shown in process 300, a number of messages and responses are transmitted between a user operating a mobile device 104 and a wallet service provider 106, a payment network 108 and an issuer 110 to provision a payment card 102 into a wallet application of the mobile device 104. As shown, the payment network 108 may include multiple devices or services 109a-n (although only two such services are shown in the process 300). The services 109a-n may include, for example, a service 109a to tokenize information received from the payment card 102. Such a service may be, for example, the MasterCard Digital Enablement Service (“MDES”) offered by the applicant. The services 109a-n may also include, for example, one or more services 109n to validate a cryptogram received from the provisioning data from the payment card 102 and the mobile device 104. For example, in the context of an EMV payment card, the cryptogram may be an ARQC. This cryptogram may be encoded and stored in a financial transaction message such as data element 55 (or “DE55”) of a message pursuant to ISO-8583. The payment network 108 may include one or more services 109 which are configured to validate an ARQC. Those different services are not shown in FIG. 3, instead, they are shown as validation 109n. Whichever service (or services) is used to validate the ARQC, a response is returned validating or not validating the ARQC.

The process 300 begins at (1) where a user interacts with a mobile wallet application of a mobile device 104 to initiate provisioning of payment card details associated with a payment card 102. Pursuant to some embodiments, this interaction may include the user interacting with a user interface (such as the user interface 600 of FIG. 6) displayed on the mobile device 104. The user interface may prompt the user to “tap” their card to the mobile device 104 to initiate contactless provisioning. Those skilled in the art, upon reading the present disclosure, will appreciate that other user interfaces may also be displayed to the user to initiate provisioning. For example, the user may interact with a user interface to launch a mobile wallet application, to select an option in the mobile wallet application to initiate provisioning, etc.

As discussed above, the payment card 102 may be an EMV compatible contactless payment card, and, as such, may have circuitry in the payment card 102 that stores information including information identifying a payment account associated with the payment card as well as data usable to generate one or more cryptograms (including, for example, a card key). The information identifying a payment account may include a primary account number (“PAN”) and an expiration date associated with the PAN. As will be used herein, the PAN will be referred to as an FPAN (or funding account PAN). When the payment card 102 is “tapped” or positioned proximate the mobile device 104, information from the payment card 102 is contactlessly read by the mobile device 104 with the mobile device 104 operating as a contactless reader. This contactless interaction may include issuance of a read record message or command from the mobile device 104 at message (2). The payment card 102 responds with information including the FPAN and the expiration date at (3). The contactless interaction may further include issuance of a generate ARQC message or command from the mobile device 104 at (4). This EMV message causes the payment card 102 to generate a cryptogram (the ARQC) using a card key stored on the payment card 102. The ARQC is provided to the mobile device 104 at (5) via contactless communication.

In some embodiments, such as described in conjunction with FIG. 2 above, the processing may include prompting the cardholder to enter a PIN or other information. In embodiments where EMV-compliant messaging are followed, processing continues by the mobile device 104 (under control of the mobile application) at (6) where the mobile device 104 generates a data element referred to as “Data Element 55” (DE55). DE55 (also referred to as “field 55”) is a field of a financial transaction message in accordance with ISO Standard ISO-8583. This field is allocated for EMV related data in payment transactions. Embodiments utilize this field to pass the ARQC generated at (6) in a payment network request message along with the FPAN and the expiration date read from the payment card 102.

Processing continues at (7) where the mobile device 104 transmits the payment network request message (including the FPAN, the expiration date and the DE55 data) to a wallet service provider 106. Pursuant to some embodiments, the message (7) is transmitted from the mobile device 104 to the wallet service provider 108 via a wireless communication link (e.g., via a cellular or other network communication). Upon receipt of the request message, the wallet service provider 106 determines whether the payment card 102 is eligible to be contactlessly provisioned in the mobile wallet of the mobile device 104. This determination is made based on information sent from the wallet service provider 106 to a payment network 108 at (8). The wallet service provider 106 may transmit a message to request that the payment card be checked (e.g., as a “checkCard” message) which includes the FPAN and the expiration date as well as the DE55 information. In some embodiments, this information is routed to a service such as the MDES service 109a of the payment network 108. The MDES service 109a may interact with one or more services 109n of the payment network 108 (at (9)) to obtain a validation result indicating whether or not the payment card 102 is eligible to be provisioned using embodiments of the present invention. In some embodiments, the service 109n may, based on the FPAN, the expiry date and the DE55 data, return a response based on whether or not the issuer associated with the payment card 102 participates in the provisioning system of the present invention.

The response (10) returned from the service 109n may be based on a number of rules such as those shown in Table 1 below. For example, if the service 109 determines that the issuer does participate in the provisioning system of the present invention (e.g., as shown in rows 1 and 2 of Table 1), and if the payment network 108 is able to validate the ARQC from the DE55 data (that is, the payment network 108 is able to validate that the payment card is valid), as shown in row 1 of Table 1, then a validation response may be returned at (11) indicating that the payment card 102 may be provisioned using the contactless approach of the present invention.

If the issuer does participate in the provisioning system of the present invention, but the payment network 108 is not able to validate that the payment card is valid (e.g., the ARQC is not valid), as shown in row 2 of Table 1, then the validation response at (11) may be a failure (and the payment card 102 is not able to be provisioned using the contactless techniques of the present invention). If the issuer participates in the provisioning system of the present invention, but the payment network 108 either does not have access to the requisite keys to validate the ARQC or there is some other indication that the issuer 110 is to do the validation (as shown in row 3 of Table 1), then the response at (11) may be a success, but issuer validation of the ARQC may be required (as discussed below).

If the issuer does not participate (as shown in row 4 of Table 1), then the response returned at (11) is a failure and the payment card 102 may not be contactlessly provisioned using embodiments of the present invention.

The response returned at (11) may include a flag indicating whether the validation was successful or not. Further, the response at (11) may indicate whether or not the issuer is doing the validation (e.g., in the scenario shown in row 3 of Table 1). If the response is a failure (e.g., the payment card 102 is not able to be provisioned using the contactless provisioning of the present invention), a message may be displayed to the cardholder (e.g., via a user interface such as FIG. 6) informing the cardholder that such contactless provisioning is not available for the payment card 102. The message presented to the cardholder may vary based on the nature of the failure. For example, if the issuer 110 simply doesn't participate, the user may be prompted to manually enter the payment card information into the mobile wallet of the mobile device 104 (e.g., using existing processes). As another example, if the issuer participates but the chip validation failed (e.g., the ARQC could not be validated), then the cardholder may be presented with a message indicating that no provisioning is possible using the payment card 102. The wallet service provider 106 may continue processing based on the results (e.g., either to continue provisioning processing or not, or to require cardholder verification, etc.).

In some embodiments, the response at (11) may also include payment card product details and terms and conditions associated with the particular payment card that need to be presented to the cardholder in the event that provisioning is permitted. In some embodiments, the payment card product details and/or the terms and conditions may be returned as links to resources. For example, the product details may include an image of the payment card and may be provided as a Uniform Resource Indicator (or “URI”). As another example, the terms and conditions may include a URI which includes a checkbox for the user to indicate acceptance or non-acceptance of the terms and conditions.

This information (as well as the response) may be passed to the mobile device 104 at (12). Pursuant to some embodiments, the payment card details and terms and conditions may be identified by the payment network 108 based on portions of the FPAN (e.g., such as the bank identification number or BIN of the FPAN). In this manner, embodiments allow relevant card details and terms and conditions (or other information) to be returned to the mobile device 104 for display to the cardholder at (13). If the cardholder accepts the terms and conditions at (14) processing continues where the mobile device 104 transmits a provisioning request to the wallet service provider 106 at (15). The provisioning request may include an identifier that links the request to the validation response message (11) (e.g., such as a “nextStepToken”). In some embodiments, processing at (13) may also include a requirement that the cardholder enter a cardholder verification code (such as a “CVC2”) to validate the cardholder is in possession of the payment card 102.

Processing continues at (16) where the wallet service provider 106 transmits a linkandProvision request to the payment network 108. This request may include the identifier that links the request to the validation response message (e.g., a “nextStepToken”) as well as information identifying the type of request (e.g., indicating that the capture mode of the payment account information was via “readerMode”). The MDES service 109a of the payment network 108 may perform tokenization processing to generate a token corresponding to the FPAN of the payment card 102 (and may also establish an expiration date for the token). The MDES service 109a may then submit a request message at (17) to the issuer 110 of the payment card 102 requesting authorization to provision the payment card 102 on the mobile wallet of the mobile device 104. In the event that the processing at (9) and (10) indicated that the issuer 110 would be responsible for validation, the request message at (17) may include DE55 data for use by the issuer 110 to perform validation.

If the issuer 110 approves the request to provision (and, if necessary, performs the card validation), a response message is transmitted at (18) indicating next steps for the provisioning. In some embodiments, the next steps may be grouped into different “paths”. As an illustrative example, the next steps may be either a “yellow”, “green” or “red” path (although those skilled in the art, upon reading this disclosure, will appreciate that other paths or naming conventions may be used). A “red” path indicates that the provisioning is not permitted (e.g., the issuer validation failed). The “green” path indicates that provisioning using the contactless approach of the present invention is permitted to be performed and completed. The “yellow” path indicates that additional user authentication is required to perform the provisioning using the present invention.

Assuming that the “green” path is indicated for the payment card 102 (e.g., where the rules applied by the payment network 108 result in a scenario such as shown in row 1 of Table 1), the payment network 108 responds to the wallet service provider 106 with the token as well as confirmation to proceed with wireless provisioning pursuant to the present invention (at 19). The wallet service provider 108 interacts with the mobile device 104 at (20) to complete the provisioning of the payment card 102 in the mobile wallet of the mobile device 104. The cardholder may then use the mobile wallet of the mobile device 104 to conduct payment transactions. Processing completes at (21) where the cardholder is presented with a message indicating the payment card 102 was successfully provisioned using the contactless provisioning of the present invention. The result is an improved payment card provisioning process that allows payment card information to be contactlessly provisioned into mobile wallets of mobile devices without manual entry by a cardholder. This provides improved security and fraud prevention, improved accuracy (by reducing manual entry requirements), and an improved cardholder experience. Further, the contactless provisioning approach of the pesent invention allows wallet service providers and issuers to apply and enforce provisioning rules that may vary based on regulatory region and other criteria.

TABLE 1

| | Payment | | | | | |
|---|---|---|---|---|---|---|
| | Network | Wallet | | Issuer | | |
| Issuer | Does | Provider | Payment | receives | | Issuer |
| Participation | Validation | to prompt | Network | PAN | Recommendation | Receives |
| Flag | (result) | for CVV? | has keys? | source | Reason Code | DE55 |
| Y | Success | N | Y | Chip | Validation | N |
| | | | | | success | |
| Y | Failure | Y | Y | Chip | Validation | N |
| | | | | | failure | |
| Y | Issuer | N | N | Chip | NA | Y |
| | doing | | | | | |
| | validation | | | | | |
| N | NA | Y | Y/N | Manual | NA | N |

Further processing rules may include the following:

TABLE II

| Validation | Wallet | Recommendation |
|---|---|---|
| Result in response | Recommendation Path | Reason Code |
| Success | Yellow | Chip validation successful |
| Success | Green | Chip validation successful |
| Failure | Yellow | Chip validation failed |
| Failure | Green | Chip validation failed |

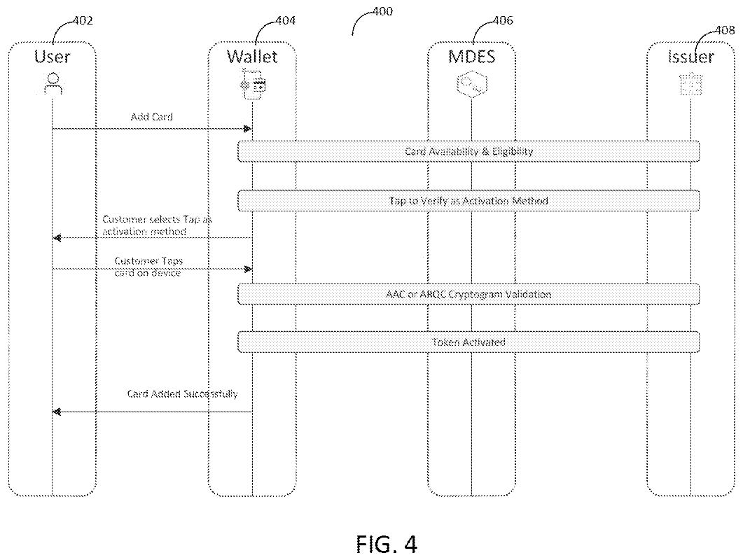

Reference is now made to FIG. 4 which is another view of the interactions involving a user during a contactless provisioning process pursuant to some embodiments. As shown in FIG. 4, a series of interactions are shown between a user 402, a wallet application 404 of a mobile device, a digitization service (shown as MDES 406) and an issuer 408. A contactless provisioning process as depicted in FIG. 4 includes several primary interactions. An interaction between the user 402 and the wallet application 404 to add a payment card to the wallet application (which, as discussed above, is performed contactlessly). After this interaction between the user 402 and the wallet application 404, a number of processes are performed (including processing to determine card availability and eligibility as discussed in conjunction with FIG. 3). If the payment card is available and eligible to be provisioned contactlessly, (e.g., “tap to verify” is a permitted activation or provisioning method), and if the user selects this as the activation or provisioning method, the user 402 may tap the payment card to the mobile device which causes a number of processes to be performed (e.g., to validate a cryptogram of the payment card and to issue and activate a token associated with the payment card). Upon successful processing, a final interaction between the wallet application 404 and the user 402 may include presenting information to the user 402 that the payment card has been successfully added to the wallet application 404 of the mobile device.

In embodiments that have been described above, a contactless payment card (e.g., a card-shaped object), is used to provide the cryptogram (and payment account data) to the mobile device. Alternatively, however, a payment device that is not card-shaped may be used in place of the contactless payment card. Examples of other types of payment devices that may be used in this role include payment wristbands, watches, fobs, etc. It should also be understood that the term “payment device” includes contactless payment cards.

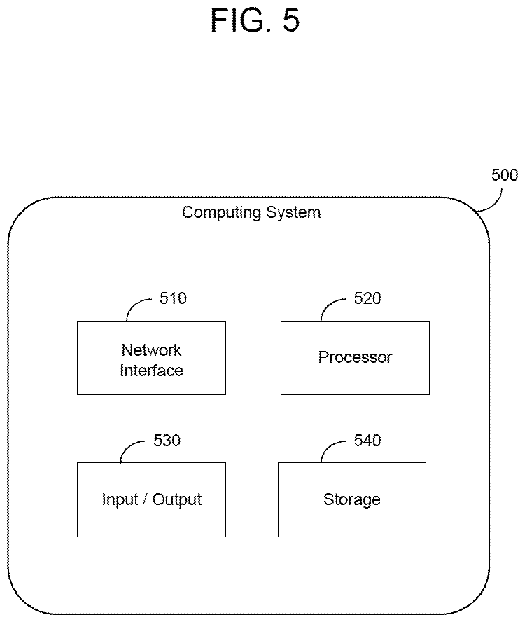

FIG. 5 illustrates a computing system 500 that may be used in any of the methods and processes described herein, in accordance with an example embodiment. For example, the computing system 500 may be a mobile device, a server, a cloud platform, a payment network system, a merchant computer, or the like. In some embodiments, the computing system 500 may be distributed across multiple computing devices. The computing system 500 may be one or more of the mobile device 104, the wallet service provider 106, the payment network 108 and/or the issuer 110. Those skilled in the art will appreciate that systems such as the wallet service provider 106, the payment network 108 and the issuer 110 may in practical application utilize a number of computing systems such as the system depicted in FIG. 5.

Referring to FIG. 5, a computing system 500 includes a network interface 510, a processor 520, an input/output 530, and a storage device 540 such as an in-memory storage, and the like. Although not shown in FIG. 5, the computing system 500 may also include or be electronically connected to other components such as a display, an input unit(s), a receiver, a transmitter, a persistent disk, and the like. The processor 520 may control or replace the other components of the computing system 500.

The network interface 510 may transmit and receive data over a network such as the Internet, a private network, a public network, a payment network, an enterprise network, and the like. The network interface 510 may include a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The input/output 530 may include an interface, a port, a cable, a bus, a board, a wire, and the like, for inputting and outputting data to and from the computing system 500. For example, data may be output to an embedded display of the computing system 500, an externally connected display, a display connected to the cloud, another device, and the like. The network interface 510, the input/output 530, the storage device 540, or a combination thereof, may interact with applications executing on other devices.

The storage device 540 is not limited to a particular storage device and may include any known memory device such as RAM, ROM, hard disk, and the like, and may or may not be included within a database system, a cloud environment, a web server, or the like. The storage device 540 may store software modules or other instructions which can be executed by the processor 520 to perform the methods described herein.

As an example, the processor 520 may execute one or more software modules or other instructions to process information received from a mobile device including payment card information from a storage device of a payment card. Further instructions may be executed to determine whether the payment card is eligible for provisioning on a wallet application of a mobile device and to obtain a tokenized version of the payment card information. Instructions may also be executed to transmit the tokenized version of the payment card information to a mobile device for provisioning in a wallet application of the mobile device.

Reference is now made to FIG. 6 which is an illustrative user interface 600 of a mobile device 104 that may be presented at the initiation of a provisioning process pursuant to some embodiments. Those skilled in the art will appreciate that a number of different user interfaces may be displayed to a user to facilitate the provisioning process of the present invention. As discussed above, the user interface 600 may display one or more screens that guide a cardholder through a provisioning process pursuant to the present invention.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable medium/media, thereby making a computer program product, i.e., an article of manufacture, according to the discussed examples of the disclosure. For example, the non-transitory computer-readable medium may be, but is not limited to, a fixed drive, diskette, optical disk, magnetic tape, flash memory, external drive, semiconductor memory such as read-only memory (ROM), random-access memory (RAM), and/or any other non-transitory device or system.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program, apparatus, cloud storage, and/or device (e.g., magnetic discs, optical disks, memory, programmable logic devices (PLDs)) used to provide machine instructions and/or data to a programmable processor, including a non-transitory machine-readable medium that receives machine instructions as a machine-readable signal. The “machine-readable medium” and “computer-readable medium,” however, do not include transitory signals.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. A contactless provisioning method, comprising:
receiving, from a mobile device, payment card information including information contactlessly read from a storage device of a payment card;
generating a message requesting confirmation that the payment card is eligible for contactless provisioning on a wallet application of the mobile device;
generating a second message requesting that a tokenized version of the payment card information be generated; and
causing the tokenized version of the payment card information to be provisioned on the wallet application.

2. The method of claim 1, further comprising:
receiving, in response to the message requesting confirmation that the payment card is eligible for contactless provisioning, a response message, the response message including a flag, the flag indicating one of a success and a fail; and
causing a message to be displayed to a user of the mobile device, the contents of the message based on the flag.

3. The method of claim 2, further comprising:
determining that a cardholder verification process is required, the determining based on the flag.

4. The method of claim 2, wherein the response message further includes an indication that issuer verification is required.

5. The method of claim 2, further comprising:
identifying, based on the payment card information, a link to a terms and conditions agreement to be presented to a user for acceptance.

6. The method of claim 5, wherein the flag indicates a success and the contents of the message include the link to the terms and conditions agreement.

7. The method of claim 6, further comprising:
receiving, prior to generating the second message, information indicating a user's acceptance of the terms and conditions agreement.

8. The method of claim 4, further comprising:
receiving, prior to generating the second message, information indicating validation of a cardholder validation code.

9. A mobile device, comprising:
a memory configured to store a mobile wallet application;
a contactless interface configured to contactlessly read information from a contactless payment card; and
a processor configured to
receive a request from a user to contactlessly provision payment card information into the mobile wallet application;
contactlessly read payment card information from the contactless payment card;
generate a cryptogram including the payment card information;
generate a message requesting confirmation that the contactless payment card is eligible for contactless provisioning on the mobile wallet application;
receive a response message, the response message including a flag, the flag indicating at least one of (i) the contactless payment card is eligible for contactless provisioning on the mobile wallet application and (ii) the contactless payment card is not eligible for contactless provisioning on the mobile wallet application;
cause a message to be displayed to a user of the mobile device, the contents of the message based on the flag; and
contactlessly provision a tokenized version of the payment card information in the mobile wallet application in the event that the contactless payment card is eligible for contactless provisioning on the mobile wallet application.

10. The mobile device of claim 9, wherein the contents of the message to be displayed to the user include terms and conditions to be accepted by the user, the terms and conditions identified based at least in part on the payment card information.

11. The mobile device of claim 9, wherein the processor is further configured to:
generate a provisioning message based on the flag of the response message, the provisioning message causing the generating of the tokenized version of the payment card information.

12. The mobile device of claim 11, wherein the response message further includes information indicating that issuer verification is required and wherein the provisioning message is generated with information requesting issuer verification of the cryptogram.

13. The mobile device of claim 9, wherein the flag indicates the contactless payment card is not eligible for contactless provisioning if the cryptogram cannot be verified.

14. A non-transitory machine-readable medium storing instructions that, when executed by at least one programmable processor, cause the at least one programmable processor to perform operations comprising:
receive a request from a user to contactlessly provision payment card information into the mobile wallet application;
contactlessly read payment card information from the contactless payment card;
generate a cryptogram including the payment card information;
generate a message requesting confirmation that the contactless payment card is eligible for contactless provisioning on the mobile wallet application;
receive a response message, the response message including a flag, the flag indicating at least one of (i) the contactless payment card is eligible for contactless provisioning on the mobile wallet application and (ii) the contactless payment card is not eligible for contactless provisioning on the mobile wallet application;
cause a message to be displayed to a user of the mobile device, the contents of the message based on the flag; and
contactlessly provision a tokenized version of the payment card information in the mobile wallet application in the event that the contactless payment card is eligible for contactless provisioning on the mobile wallet application.

15. The non-transitory machine-readable medium storing instructions of claim 14, further comprising instructions that, when executed by the at least one programmable processor, cause the at least one programmable processor to perform operations comprising:
generate a provisioning message based on the flag of the response message, the provisioning message causing the generating of the tokenized version of the payment card information.

16. The non-transitory machine-readable medium storing instructions of claim 14, wherein the response message further includes information indicating that issuer verification is required and wherein the provisioning message is generated with information requesting issuer verification of the cryptogram.

17. The non-transitory machine-readable medium storing instructions of claim 14, wherein the flag indicates the contactless payment card is not eligible for contactless provisioning if the cryptogram cannot be verified.
